(19) United States
(12) Patent Application Publication
(10) Pub. No.: US 2025/0253452 A1
(43) Pub. Date: Aug. 7, 2025

(54) BATTERY ASSEMBLY

(71) Applicant: SK On Co., Ltd., Seoul (KR)

(72) Inventors: Min Song KANG, Daejeon (KR); Ji Woong KIM, Daejeon (KR); Hae Ryong JEON, Daejeon (KR)

(21) Appl. No.: 19/033,497

(22) Filed: Jan. 22, 2025

(30) Foreign Application Priority Data
Feb. 5, 2024 (KR) 10-2024-0017510

(51) Int. Cl. H01M 50/148; H01M 10/653; H01M 50/105; H01M 50/178; H01M 50/244; H01M 50/262; H01M 50/505

(52) U.S. Cl. CPC H01M 50/148; H01M 10/653; H01M 50/105; H01M 50/178; H01M 50/244; H01M 50/262; H01M 50/505

(57) ABSTRACT

A battery assembly of the present disclosure includes: a plurality of battery cells disposed along a preset stacking direction; a cell cover covering a tab portion protruding from one side of at least one battery cell among the plurality of battery cells; an accommodating case accommodating the plurality of battery cells; and a side member extending from the accommodating case toward the plurality of battery cells, wherein at least a part of the cell cover is positioned on the upper portion of the side member and supported by the side member.

### CROSS-REFERENCE TO RELATED PATENT APPLICATION

The present application claims priority under 35 U.S.C. § 119(a) to Korean patent application number 10-2024-0017510 filed on Feb. 5, 2024 the entire disclosure of which is incorporated by reference herein.

### BACKGROUND OF THE INVENTION

### 1. Field

The present disclosure relates to a battery assembly. Specifically, it relates to a battery assembly having improved stability and performance.

### 2. Description of the Related Art

A secondary battery is a battery that is made to convert electrical energy into chemical energy and store it so that it may be reused multiple times through charging and discharging. Secondary batteries are widely used across industries due to their economical and eco-friendly characteristics. In particular, among secondary batteries, lithium secondary batteries are widely used throughout industries, including portable devices that require high-density energy.

In order to increase the capacity and improve the performance, one or more secondary batteries may be grouped together to manufacture and use them as a battery module or battery pack. At this time, research is actively being conducted on a combination structure that can improve energy density while increasing stability by minimizing the components that fix the grouped secondary batteries.

### SUMMARY OF THE INVENTION

A problem that the present disclosure aims to solve to increase the volume ratio within a battery assembly, thereby improving the energy density and performance of the battery assembly.

In addition, the present disclosure can improve the stability of a battery assembly by stably fixing a battery cell within a case.

In addition, the present disclosure can be widely applied in the field of electric vehicles, battery charging stations, and green technology, such solar power generation, and wind power generation using batteries.

In addition, the present disclosure can be used in eco-friendly electric vehicles, hybrid vehicles, and others to prevent air pollution and climate change by suppressing greenhouse gas emissions.

A battery assembly of the present disclosure may include: a plurality of battery cells disposed along a preset stacking direction; a cell cover covering a tab portion protruding from one side of at least one battery cell among the plurality of battery cells; an accommodating case accommodating the plurality of battery cells; and a side member extending from the accommodating case toward the plurality of battery cells, wherein at least a part of the cell cover is positioned on the upper portion of the side member and supported by the side member.

The cell cover may include a coupling portion provided to protrude toward the side member, and the coupling portion may be positioned on the upper portion of the side member.

the coupling portion may be formed in a plural number to be spaced apart along the stacking direction.

The coupling portion may include a through-hole formed along the height direction of the accommodating case.

The cell cover may include: a covering portion covering one surface where a tab portion of at least one battery cell is positioned; and a protecting portion extending from one end of the covering portion and positioned at a lower portion of at least one battery cell.

The side member may include a recessed portion formed to be recessed along the height direction of the accommodating case at a position corresponding to at least a part of the cell cover.

The battery assembly may further include a busbar assembly electrically connecting the plurality of battery cells, and the busbar assembly may be positioned between the cell cover and the plurality of battery cells.

The busbar assembly may be coupled with the cell cover.

The battery assembly may further include an end plate positioned on the outside of the plurality of battery cells along the stacking direction.

The battery assembly may further include a fastening member connecting the cell cover and the side member.

The side member may include an insertion hole formed by recessing or penetrating an area along the height direction of the accommodating case.

The fastening member may penetrate the cell cover, and one end of the fastening member may be inserted into the insertion hole.

The battery assembly may further include an upper cover covering connected to the cell cover and covering an upper surface of the plurality of battery cells.

At least a part of the upper cover may be positioned on an upper portion of the side member.

The battery assembly may further include a fastening member connecting the upper cover, the cell cover, and the side member.

The fastening member may penetrate the upper cover and the cell cover, and at least a part of the fastening member may be inserted into the side member.

The accommodating case may further include: an accommodating body including an opening on one side thereof and accommodating the plurality of battery cells through the opening; and an accommodating cover coupled with at least one of the accommodating body or the side member to close the opening.

The battery assembly may further include a pressurizing portion of an elastic material on one surface of the accommodating cover, the surface facing the plurality of battery cells.

The battery assembly may further include a heat-blocking member positioned to face an adjacent battery cell between the plurality of battery cells.

The battery assembly may further include a heat-conducting portion applied to the accommodating case and including a heat-conducting material.

According to one embodiment of the present disclosure, the volume ratio within a battery assembly can be increased, thereby improving the energy density and performance of the battery assembly.

In addition, a battery cell according to another embodiment of the present disclosure may be stably fixed within a case, thereby improving the stability of a battery assembly.

### BRIEF DESCRIPTION OF THE DRAWINGS

FIG. 1 shows an exploded view illustrating a battery assembly according to one embodiment of the present disclosure.

FIG. 2 shows a diagram illustrating a battery cell according to one embodiment of the present disclosure.

FIG. 3 shows a diagram illustrating a part of a battery assembly according to one embodiment of the present disclosure.

FIG. 4 shows a diagram illustrating a busbar assembly according to one embodiment of the present disclosure.

FIG. 5 shows a diagram illustrating a cell cover and a busbar assembly according to one embodiment of the present disclosure.

FIG. 6 shows a diagram illustrating a sensing portion according to one embodiment of the present disclosure.

FIG. 7 shows a diagram illustrating an upper cover, a cell cover, and an end plate connected to each other according to one embodiment of the present disclosure.

FIG. 8 shows a diagram illustrating an accommodating case according to one embodiment of the present disclosure.

FIG. 9 shows an enlarged view illustrating the S1 part of FIG. 8.

FIG. 10 shows a diagram illustrating a battery cell accommodated in an accommodating case according to one embodiment of the present disclosure.

FIG. 11 shows an enlarged view illustrating the S2 area of FIG. 10.

FIG. 12 shows a diagram illustrating a cross-section taken along line AA′ of FIG. 10.

FIG. 13 shows a diagram illustrating a cross-section taken along line BB′ of FIG. 10.

FIG. 14 shows a diagram illustrating a top view of a battery assembly according to one embodiment of the present disclosure.

### DETAILED DESCRIPTION

Hereinafter, the present disclosure will be described in detail with reference to the attached drawings. This is merely illustrative, and the present disclosure is not limited to the specific embodiments described in an illustrative manner.

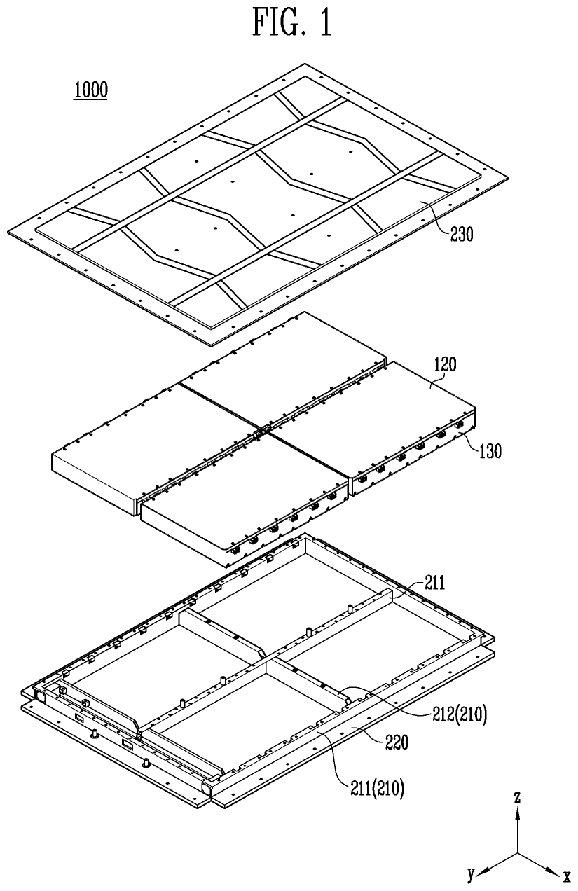

FIG. 1 shows an exploded view illustrating a battery assembly according to one embodiment of the present disclosure.

The battery assembly 1000 according to the present disclosure is a concept that collectively refers to a battery module or a battery pack. Therefore, the battery assembly 1000 according to the present disclosure may refer to not only a battery module but also a battery pack that accommodates battery cells 10 without a battery module, such as a cell-to-pack (hereinafter referred to as CTP).

The battery assembly 1000 includes a plurality of battery cells 10 disposed along a preset stacking direction and an accommodating case 200 accommodating the plurality of battery cells 10. Referring to FIG. 1, a plurality of battery cells 10 may be positioned in the accommodating case 200.

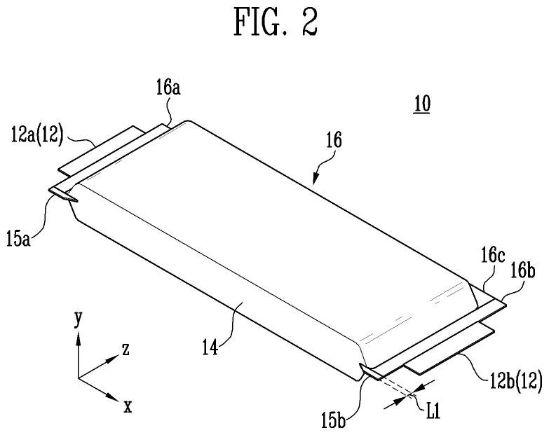

FIG. 2 shows a diagram illustrating a battery cell 10 according to one embodiment of the present disclosure. Each of the plurality of battery cells 10 may include an electrode assembly (not shown), a tab portion 12, at least one protruding portion 15a and 15b, and an exterior material 16. An electrode assembly may be accommodated in an internal space formed by an exterior material 16. An electrode assembly may include a cathode and an anode. An electrode assembly may further include a separator disposed between a cathode and an anode. In addition, an electrode assembly may further include an electrolyte that allows to form a flow of ions between a cathode and an anode. In an embodiment, an electrode assembly may have a structure in which a cathode and an anode are alternately stacked with a separator therebetween.

A tab portion 12 may protrude from one side of a battery cell 10. A tab portion 12 may be formed by protruding from one side surface of an exterior material 16. A tab portion 12 may electrically connect an electrode assembly and the outside.

A tab portion 12 may include a first tab portion 12a and a second tab portion 12b. A first tab portion 12a and a second tab portion 12b may be formed to protrude from different side ends of an exterior material 16 to the outside. For example, referring to FIG. 2, a first tab portion 12a may protrude from the left end of an exterior material 16 in the −X-axis direction, and a second tab portion 12b may protrude from the right end in the +X-axis direction. However, this is only one example, and a first tab portion 12a and a second tab portion 12b may protrude in parallel from one side surface of an exterior material 16.

An exterior material 16 may surround an electrode assembly and protect the electrode assembly. An exterior material 16 may include a sealing portion. A sealing portion may be formed at an external end of an electrode assembly. A sealing portion may be a part where one part of an exterior material 16 and another part thereof are joined to each other. A sealing portion may be formed by joining in various ways such as adhesive heating, compression, welding, and the like.

In an embodiment, the sealing portion may include a first sealing portion 16a, a second sealing portion 16b, and a third sealing portion 16c. A first sealing portion 16a may be formed at one side end of an electrode assembly, and a second sealing portion 16b may be formed at the other side end of the electrode assembly. A third sealing portion 16c may be formed on another side end of the electrode assembly that is different from the first sealing portion 16a and the second sealing portion 16b.

An exterior material 16 may include a folding portion 14. A folding portion may be a part where an exterior material 16 is folded. A folding portion may be formed on one side surface of an exterior material 16. A folding portion may be formed on one side surface of an exterior material 16 where a tab portion 12 is not positioned.

In an embodiment, a folding portion may be formed on a lower surface of an exterior material 16. A battery cell 10 may be positioned in an accommodating case 200 in a direction in which a folding portion faces the ground. Referring to FIG. 2, a folding portion may be formed on a surface of an exterior material 16 facing the −Z-direction.

A protruding portion 15a and 15b may be formed on a lower surface of an exterior material 16. The lower surface may be a surface facing an upper surface of an accommodating body 220 of the exterior material 16, which will be described later. A protruding portion 15 may protrude from a folding portion by a preset length. For example, a protruding portion 15 may protrude by L1 in the −Z-axis direction based on the folding portion.

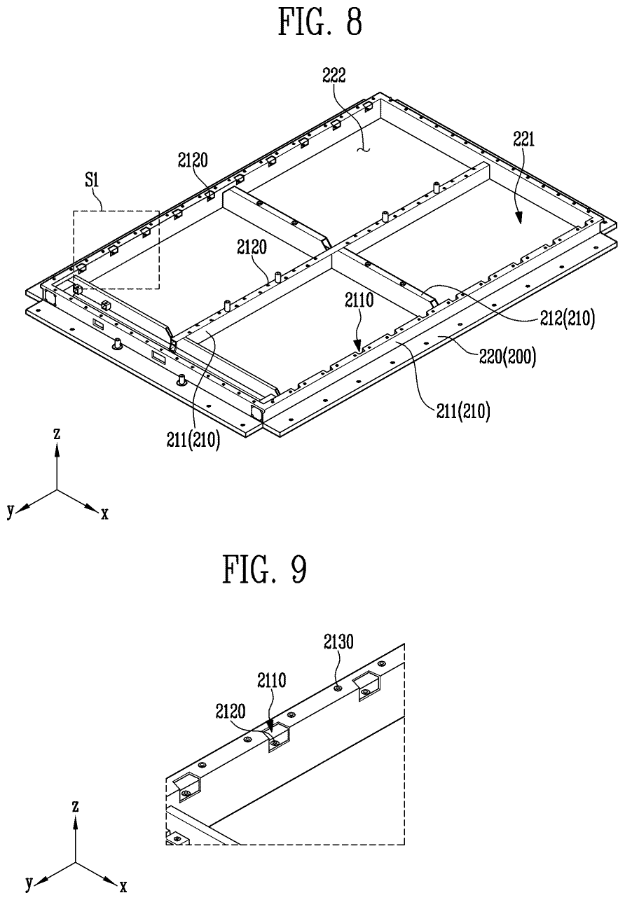

Meanwhile, an accommodating case 200 is intended to protect a plurality of battery cells 10 from external impacts such as vibration. An accommodating case 200 may include an accommodating body 220 that forms a part of an accommodating space 222 accommodating a plurality of battery cells 10. An accommodating case 200 will be described in detail with reference to FIGS. 8 to 11 below.

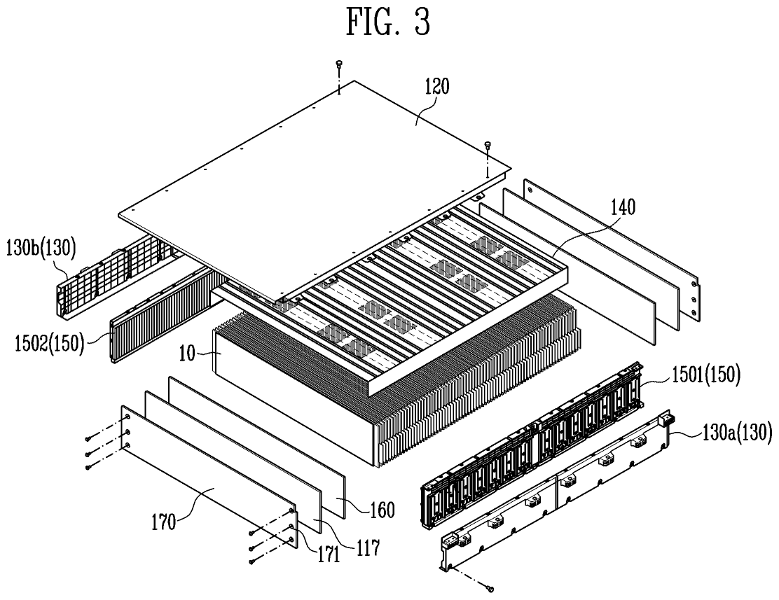

FIG. 3 shows a diagram illustrating a part of a battery assembly according to one embodiment of the present disclosure.

A battery assembly 1000 of the present disclosure includes a plurality of battery cells 10 disposed along a preset stacking direction and a cell cover 130 covering a tab portion 12 protruding toward one side of at least one of the plurality of battery cells 10. Referring to FIG. 3, a preset stacking direction of the present disclosure may refer to a direction parallel to the Y-axis.

A cell cover 130 may fix at least a part of the plurality of battery cells 10 to an accommodating case 200. A cell cover 130 may extend along a preset stacking direction. Since a tab portion 12 protrudes from a plurality of battery cells 10 along a preset stacking direction, a cell cover 130 also extends along the preset stacking direction to cover the tab portion 12.

A cell cover 130 may be positioned to face a tab portion 12 in a direction in which a tab portion 12 of a plurality of battery cells 10 are positioned, in order to cover the tab portion 12. A cell cover 130 may include a first cell cover 130a positioned at one end of a plurality of battery cells 10 and a second cell cover 130b positioned at the other end of the plurality of battery cells 10. In other words, a first cell cover 130a and a second cell cover 130b may cover each tab portion 12 of a plurality of battery cells 10, and a plurality of battery cells 10 may be disposed between a first cell cover 130a and a second cell cover 130b.

As described above, a first tab portion 12a and a second tab portion 12b may be positioned in opposite directions. A first cell cover 130a may be positioned to face a first tab portion 12a, and a second cell cover 130b may be positioned to face a second tab portion 12b.

For example, referring to FIG. 3, a first cell cover 130a may be positioned to face a first tab portion 12a in the +X-direction of a plurality of battery cells 10, and a second cell cover 130b may be positioned to face a second tab portion 12b in the −X-direction.

A first cell cover 130a may be provided in one or more pieces. A plurality of first cell covers 130a may be disposed along a preset stacking direction and may be connected to each other. Similarly, a second cell cover 130b may also be provided in one or more pieces, and a plurality of second cell covers 130b may be disposed along a preset stacking direction and may be connected to each other.

As the number of battery cells 10 increases, it may become difficult to cover a tab portion 12 positioned on one side of a plurality of battery cells 10 with one cell cover 130. This is because, as the number of battery cells 10 increases, the length of a tab portion 12 must increase. As the length of a cell cover 130 increases, the structural stability of the cell cover 130 deteriorates, and the manufacturing efficiency may decrease during the manufacturing process.

Therefore, a first cell cover 130a or a second cell cover 130b are provided in a plural number, they may be connected to each other to cover a tab portion 12 positioned on one side of a plurality of battery cells 10.

Meanwhile, a battery assembly 1000 of the present disclosure may include a plurality of battery cells 10 and a busbar 151 electrically connected to the outside. In addition, the present disclosure may further include a busbar frame 155 supporting a busbar 151 and a battery cell 10. A busbar 151 and a busbar frame 155 may be collectively referred to as a busbar assembly 150. In other words, a busbar assembly 150 may include a busbar 151 electrically connected to a plurality of battery cells 10, and may further include a busbar frame 155 supporting the busbar 151.

A busbar assembly 150 may be electrically connected to the outside to store (or charge) electric energy in a plurality of battery cells 10, or supply (or discharge) electric energy stored in the plurality of battery cells 10 to the outside.

A busbar assembly 150 may be positioned between a cell cover 130 and a plurality of battery cells 10. For example, a busbar assembly 150 may be positioned between a first cell cover 130a and a first tab portion 12a, or between a second cell cover 130b and a second tab portion 12b.

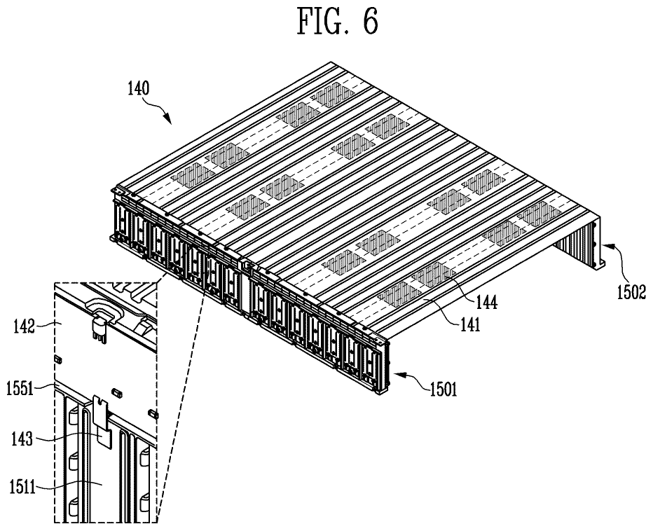

Meanwhile, the battery assembly 1000 of the present disclosure may further include a sensing portion 140. A sensing portion 140 may include an electrical device for sensing and controlling a plurality of battery cells 10. For example, a sensing portion 140 may measure the voltage, current, and state of charge of at least a part of a plurality of battery cells 10, and communicate the measured information to the outside. The sensing portion 140 may be formed on one side of the plurality of battery cells 10. For example, a sensing portion 140 may be formed on an upper portion of the plurality of battery cells 10. A sensing portion 140 will be described in detail with reference to FIG. 6 below.

In addition, a battery assembly 1000 of the present disclosure may further include a buffering member 117 or a heat-blocking member 160 positioned between a plurality of battery cells 10.

A heat-blocking member 160 may be positioned between a plurality of battery cells 10 to face an adjacent battery cell 10. A heat-blocking member 160 may be positioned in each space between battery cells 10. A heat-blocking member 160 may be positioned between battery groups formed by grouping together a plurality of battery cells 10. The same applies to a buffering member 117.

A buffering member 117 may prevent damage to a battery cell 10 by relieving the pressure caused by the expansion of the battery cell 10. A heat-blocking member 160 can serve as a thermal barrier to prevent flame or heat from propagating to another adjacent battery cell 10 when one battery cell 10 experiences thermal runaway.

Meanwhile, a battery assembly 1000 of the present disclosure may further include end plates 170 at both ends of a plurality of battery cells 10 along a stacking direction. An end plate 170 may be positioned on the outside of a plurality of battery cells 10 along a preset stacking direction. An end plate 170 may be each provided on an outermost side of a plurality of battery cells 10. An end plate 170 is intended to prevent both side surfaces of a battery assembly 1000 from being exposed to the outside.

An end plate 170 may be connected to a busbar assembly 150. One end of an end plate 170 may be connected to a first busbar assembly 1501, and the other end may be connected to a second busbar assembly 1502. End plates 170 provided on both sides of a plurality of battery cells 10 may be connected to a first busbar assembly 1501 and a second busbar assembly 1502, so that a plurality of battery cells 10 may be accommodated therein.

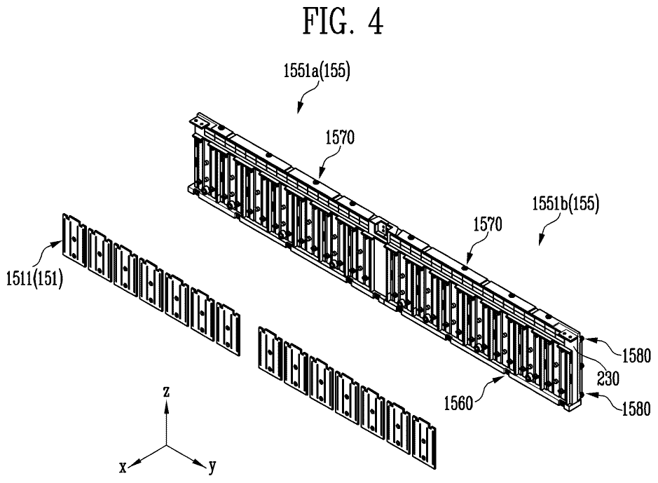

FIG. 4 shows a diagram illustrating a busbar assembly 150 according to one embodiment of the present disclosure.

A busbar assembly 150 may include a busbar 151 and a busbar frame 155. A busbar 151 may be supported by a busbar frame 155. A busbar 151 may be positioned in a direction farther away from a plurality of battery cells 10 than from a busbar frame 155.

Each tab portion 12 of a plurality of battery cells 10 may be inserted into slit holes (not shown) formed on a busbar frame 155. This is only an example, and a part of slit holes may also be formed as open slits, and a tab portion 12 may be inserted into a busbar frame 155 in another manner to be electrically connected to a busbar 151.

Meanwhile, a busbar assembly 150 of the present disclosure may be connected to an adjacent component. A busbar assembly 150 may be coupled to a cell cover 130 or to an end plate 170, or may be connected to an upper cover 120, which will be described later. A busbar assembly 150 may be connected to at least one of the cell cover 130, the end plate 170, and the upper cover 120.

To this end, a busbar frame 155 may include a frame-connecting hole 1560 to be connected to an adjacent component. A frame-connecting hole 1560 may be formed on the front surface of a busbar frame 155. The front surface of a busbar frame 155 may refer to a surface facing the +X-direction. A cell cover 130 and a busbar frame 155 may be connected through a frame-connecting hole 1560. To this end, a cell cover 130 may include a cell cover-connecting hole 134 at a position corresponding to a frame-connecting hole 1560.

A fixing member 300 may connect a cell cover 130 and a busbar frame 155. A fixing member 300 may penetrate a cell cover 130. In addition, a fixing member 300 may penetrate a busbar frame 155, or at least a part of a fixing member 300 may be inserted into a busbar frame 155. For example, a fixing member 300 may be a bolt, and a bolt may penetrate a cell cover connecting hole 134 and then be inserted into a frame-connecting hole 1560 to connect each other.

In addition, a busbar frame 155 may include a frame-combining hole 1580. A frame-combining hole 1580 may be formed on a side surface of a busbar frame 155. A side surface of a busbar frame 155 may refer to a surface facing the −Y-direction or the +Y-direction. A busbar frame 155 may be connected to an end plate 170 through a frame-combining hole 1580. In the same manner as a frame connecting hole 1560 is connected, a fixing member 300 may penetrate an end plate 170 and then at least a part thereof may be inserted into a busbar frame 155 to connect each other.

In addition, a busbar frame 155 may include a frame-fixing hole 1570. A frame-fixing hole 1570 may be formed on an upper surface of a busbar frame 155. An upper surface of a busbar frame 155 may refer to a surface facing the +Z-direction. A busbar frame 155 may be connected to a cell cover 130 through a frame-fixing hole 1570. In addition, a busbar frame 155 may be connected to an upper cover 120, which will be described later, through a frame-fixing hole 1570. In the same manner as a frame-connecting hole 1560 is connected, an upper cover 120 and a busbar assembly 150 may be connected through a frame-fixing hole 1570. To this end, a cell cover 130 may include a cell cover-fixing hole 135. A fixing member 300 may penetrate a cell cover-fixing hole 135 and then be inserted into a frame-fixing hole 1570 to connect each other.

Specifically, FIG. 4 illustrates a first busbar assembly 1501 provided on one side of a plurality of battery cells 10. A first busbar 1511 may be positioned on a front surface of a first busbar frame 1551. A first busbar 1511 may be provided in a plural number and positioned to be spaced apart from each other along a preset stacking direction.

In addition, a first busbar frame 1551 may be extended along a preset stacking direction and may be provided in a plural number. A plurality of first busbar frames 1551a and 1551b may be connected to each other. The description of a first busbar assembly 1501 may be equally applied to a second busbar assembly 1502.

Meanwhile, a busbar assembly 150 may further include a terminal 1590 to be electrically connected to the outside. A terminal 1590 may be formed of an electrically conductive material.

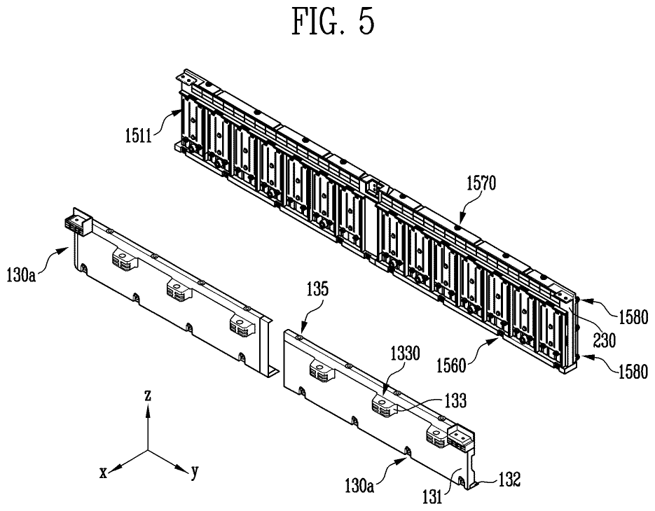

FIG. 5 shows a diagram illustrating a cell cover 130 and a busbar assembly 150 according to one embodiment of the present disclosure. Specifically, FIG. 5 illustrates a first cell cover 130a and a first bus bar assembly 1501.

A cell cover 130 may be positioned to face a front surface of a busbar assembly 150. A front surface of a first busbar assembly 1501 may refer to a surface facing the +X-direction. In contrast, a front surface of a second busbar assembly 1502 may refer to a surface facing the −X-direction.

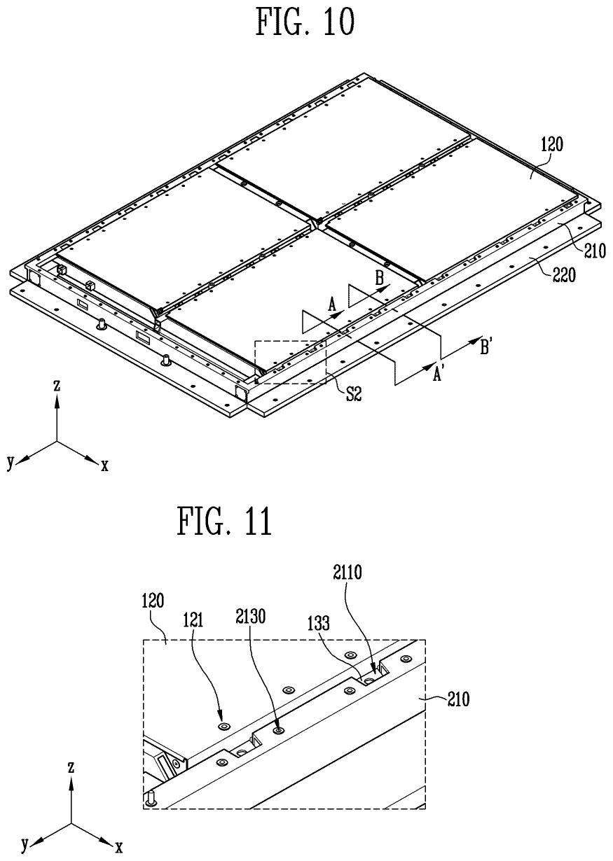

A cell cover 130 may include a coupling portion 133 provided to protrude toward a side member 210, and a coupling portion 133 may be positioned on an upper portion of a side member 210. As will be described in detail in FIGS. 10 to 15 below, a coupling portion 133 may protrude toward a side member 210. In other words, a cell cover 130 may be positioned between a side member 210 and a plurality of battery cells 10, and a coupling portion 133 may be formed to protrude toward a side member 210.

A coupling portion 133 may be formed in a plural number to be spaced apart along a preset stacking direction. The reason for forming in a plural number is to stably fix to an accommodating case 200. A coupling portion 133 may include a through-hole 1330 formed by penetrating along the height direction of an accommodating case 200. The height direction of an accommodating case 200 may refer to a direction parallel to the Z-direction. A fastening member 190, which will be described later, may penetrate a through-hole 1330 and then be fixed to a side member 210 so that a cell cover 130 and a side member 210 may be stably connected. This will be described in detail below.

Meanwhile, a cell cover 130 may include a covering portion 131 covering at least one surface where a tab portion 12 of at least one battery cell 10 is positioned, and a protecting portion 132 extending from one end of a covering portion 131 and positioned at a lower portion of at least one battery cell 10. A covering portion 131 may cover a front surface of a busbar assembly 150, and a protecting portion 132 may protect a lower portion of a battery cell 10.

A lower portion of a battery cell 10 refers to a surface of a battery cell 10 facing the −Z-direction. As described above, a battery cell 10 may include at least one protruding portion 15, and a protruding portion 15 may protrude in the −Z-direction by a preset length based on a folding portion.

When a protruding portion 15 is damaged, an insulation structure of a battery cell 10 may be damaged and the performance and stability may deteriorate, so it is necessary to protect a protruding portion 15. A protecting portion 132 of a cell cover 130 may protect a protruding portion 15 of a battery cell 10.

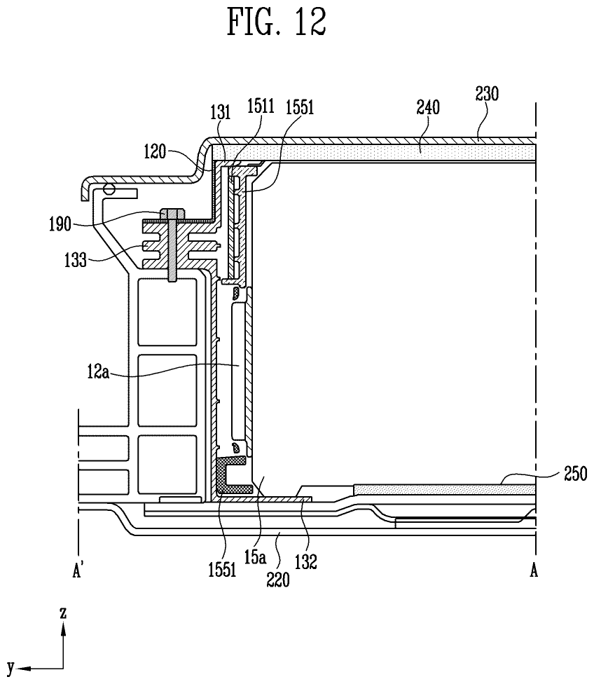

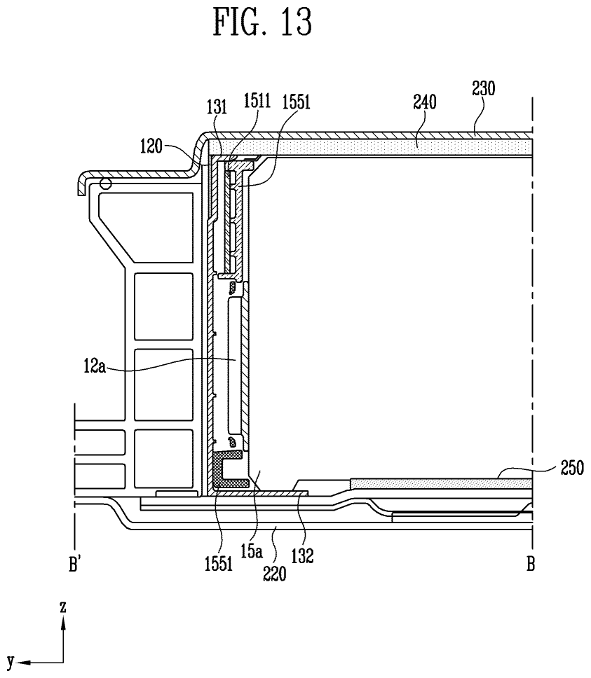

A protecting portion 132 may be formed by bending at one edge of a covering portion 131. Alternatively, a protecting portion 132 and a covering portion 131 may be formed integrally by injection molding. The positional relationship between a protecting portion 132 and a protruding portion 15 will be described in detail with reference to FIGS. 12 and 13.

Meanwhile, the other end of a covering portion 131 may be extended and positioned on an upper portion of a busbar assembly 150. A cell cover-fixing hole 135 may be formed on one surface of a cell cover 130 positioned on an upper portion of a busbar assembly 150. A cell cover-fixing hole 135 may be formed at a position corresponding to a frame-fixing hole 1570. A fixing member 300 may penetrate a cell cover-fixing hole 135 and then be inserted into a busbar assembly 150. Through this, a busbar assembly 150 and a cell cover 130 may be connected.

In addition, a cell cover-connecting hole 134 may be formed in a covering portion 131. A cell cover-connecting hole 134 may be formed at a position corresponding to a frame-connecting hole 1560.

FIG. 6 shows a diagram illustrating a sensing portion 140 according to one embodiment of the present disclosure.

Referring to FIG. 6, a sensing portion 140 may include a supporting portion 141 formed on one side of a plurality of battery cells 10, a substrate portion 142 extending from both edges of the supporting portion 141, and a measuring portion 143. A supporting portion 141 and a substrate portion 142 may be connected to each other and formed integrally, and may have a tunnel shape.

A supporting portion 141 may cover an upper surface (e.g., a surface facing the +Z-direction) of a plurality of battery cells 10. A supporting portion 141 may cover the whole or only a part of an upper surface of a plurality of battery cells 10. For example, a supporting portion 141 may be formed as a printed circuit board.

A control portion 144 controlling electrical information of a battery cell 10 and transmitting information to the outside may be formed on a supporting portion 141. For example, a supporting portion 141 may include a temperature sensor.

A substrate portion 142 may be connected to an edge of a supporting portion 141 and may be positioned on one surface of a busbar frame 155. A measuring portion 143 may be connected to a busbar 151 and may measure information of a battery cell 10. Information measured by a measuring portion 143 may be transmitted to a control portion 144 through a substrate portion 142. Without being limited thereto, a sensing portion 140 may apply a known configuration for controlling and obtaining information of a battery cell 10.

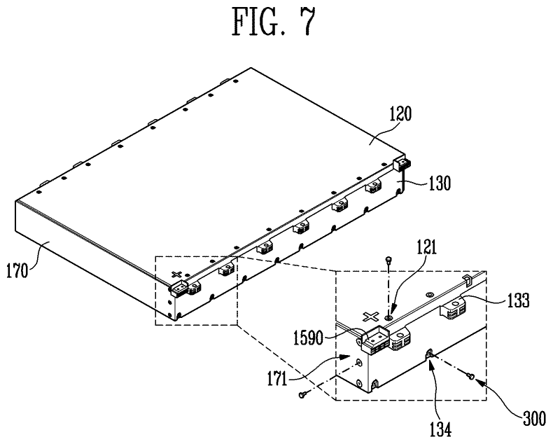

FIG. 7 shows a diagram illustrating an upper cover 120, a cell cover 130, and an end plate 170 connected to each other according to one embodiment of the present disclosure.

A battery assembly 1000 of the present disclosure may further include an upper cover 120. An upper cover 120 is intended to protect a plurality of battery cells 10. An upper cover 120 may cover one surface of a plurality of battery cells 10. For example, an upper cover 120 may protect an upper surface of a plurality of battery cells 10.

At least a part of an upper cover 120 may be positioned on an upper portion of a side member 210. An upper cover 120 may be connected to a side member 210 together with a cell cover 130 to stably support and fix a plurality of battery cells 10.

An upper cover 120 may be connected to a cell cover 130. An upper cover hole 121 may be formed on an upper cover 120 at a position corresponding to a frame-fixing hole 1570. As a result, an upper cover hole 121, a frame-fixing hole 1570, and a cell cover-fixing hole 135 may be formed at corresponding positions, and a fixing member 300 may be inserted into each hole to connect or fix each other.

In addition, a cell cover-connecting hole 134 and a frame-connecting hole 1560 may be formed at corresponding positions, and a fixing member 300 may be inserted into each hole to connect or fix each other.

Likewise, an end plate hole 171 may be formed on an end plate 170 at a position corresponding to a frame-combining hole 1580, and a fixing member 300 may be inserted into each hole to connect or fix each other.

As a result, an upper cover 120, a frame-fixing hole 1570, and an end plate 170 may be connected to form a rectangular hexahedron shape with an open lower surface of a plurality of battery cells 10. A lower surface may refer to a surface facing the −Z-direction. Meanwhile, a lower surfaces of a plurality of battery cells 10 may be protected by an accommodating case 200, and a terminal 1590 may protrude to one side and be exposed to the outside, so that a plurality of battery cells 10 may be electrically connected to the outside.

FIG. 8 shows a diagram illustrating an accommodating case 200 according to one embodiment of the present disclosure, and FIG. 9 shows an enlarged view illustrating the S1 part of FIG. 8.

An accommodating case 200 may include an accommodating body 220 including an opening 221 on one side thereof and accommodating a plurality of battery cells 10 through the opening 221. A side member 210 extending from an accommodating case 200 toward a plurality of battery cells 10 may be formed. A side member 210 may be formed on an accommodating body 220.

An accommodating case 200 may further include an accommodating cover 230 coupled with at least one of an accommodating body 220 or a side member 210 to close an opening 221. In an embodiment, at least a part of an accommodating cover 230 may be positioned on a side member 210, and the accommodating cover 230 and the side member 210 may be connected to form one side surface of an accommodating space 222.

Referring to FIG. 8, a side member 210 may extend toward an accommodating space 222 on an accommodating body 220. For example, a side member 210 may extend along the +Z-direction on an accommodating body 220.

A side member 210 may partition an accommodating space 222. An accommodating space 222 may be partitioned into a plural number of spaces by a side member 210. A side member 210 may include a first member 211 and a second member 212. A first member 211 may extend along a direction parallel to a preset stacking direction on an accommodating body 220, and a second member 212 may extend along a direction perpendicular to the first member 211.

For example, a second member 212 may be formed between a pair of facing first members 211 to define an accommodating space 222.

A side member 210 may include a recessed portion 2110 formed to be recessed along the height direction of an accommodating case 200 at a position corresponding to at least a part of a cell cover 130.

For example, a side member 210 may be formed by stacking columnar hollows along the height direction of an accommodating case 200. The hollows may extend along a horizontal direction perpendicular to the height direction. A recessed portion 2110 may be formed by cutting off a part of the outside of a hollow positioned at the top. Therefore, the hollow and the outside may be connected by the recessed portion 2110.

Specifically, referring to FIG. 9, one or more recessed portions 2110 may be formed on a first member 211. A coupling portion 133 may be positioned on each of a plurality of recessed portions 2110, so that the stability of the assembly may be improved. A recessed portion 2110 may be formed by cutting off a hollow positioned at the top, and the hollow positioned at the top may be communicated with the outside.

Meanwhile, a side member 210 may further include an insertion hole 2120 formed by recessing or penetrating an area along the height direction of an accommodating case 200. When a part of a cell cover 130 is disposed on a side member 210, an insertion hole 2120 may be formed at a position corresponding to a through-hole 1330 formed at a coupling portion 133.

A fastening member 190, which will be described later, may penetrate a through-hole 1330 and be inserted into an insertion hole 2120 to connect a cell cover 130 and a side member 210.

In an embodiment, an insertion hole 2120 may be positioned to overlap a recessed portion 2110 along the height direction of an accommodating case 200. In other words, an insertion hole 2120 may be formed on an outer side surface of a recessed portion 2110.

An insertion hole 2120 may be formed on a partition wall positioned between a hollow formed at the top along the height direction of an accommodating case 200, where a recessed portion 2110 is formed, and a hollow formed below the hollow where the recessed portion 2110 is formed. A partition wall may be recessed or penetrated to form an insertion hole 2120. Two adjacent hollows may be connected by an insertion hole 2120.

At least a part of a cell cover 130 may be positioned on a side member 210 and supported by the side member 210. For example, a coupling portion 133 may be positioned on a side member 210.

Meanwhile, an accommodating case 200 may further form a mounting hole 2130. A mounting hole 2130 may be formed by recessing or penetrating a part of an accommodating body 220 or a side member 210. Referring to FIG. 9, a mounting hole 2130 may be formed at a position of a side member 210 where a recessed portion 2110 is not formed. A mounting hole 2130 is intended to connect or fixing a side member 210 and an accommodating cover 230.

Therefore, when an accommodating cover 230 is positioned on a side member 210, a hole formed by penetrating a position corresponding to a mounting hole 2130 may be included, and each hole may be penetrated to connected each other.

The accommodating cover 230 includes a cover joining hole (not shown) located at a position that aligns with the mounting hole 2130. When the accommodating cover 230 is positioned on the side member 210, a joining member (not shown) can be inserted into both the mounting hole 2130 and the corresponding cover joining hole to connect the accommodating cover 230 to the side member 210.

FIG. 10 shows a diagram illustrating a battery cell 10 accommodated in an accommodating case 200 according to one embodiment of the present disclosure, and FIG. 11 shows an enlarged view illustrating the S2 area of FIG. 10.

Referring to FIGS. 10 and 11, an accommodating cover 230 may be coupled to a side member 210 while closing an opening 221. A coupling portion 133 of a cell cover 130 may be each positioned on a recessed portion 2110 of a side member 210.

In order for a coupling portion 133 to be positioned on a recessed portion 2110, the width of the coupling portion 133 may be smaller than the width of the recessed portion 2110. Here, the width of a coupling portion 133 refers to the length of the coupling portion 133 measured along the direction in which a first member 211 extends (e.g., the Y-direction), and the width of a recessed portion 2110 may likewise refer to the length of the recessed portion 2110 measured along the direction in which a first member 211 extends.

In addition, in order for a coupling portion 133 to be positioned on a recessed portion 2110, the cross-section of a coupling portion 133 and the cross-section of a recessed portion 2110 may have corresponding shapes. For example, referring to FIG. 10, since a recessed portion 2110 and a coupling portion 133 each have a trapezoidal shape, the coupling portion 133 may be settled at the recessed portion 2110.

The battery assembly 1000 of the present disclosure may further include a fastening member 190. A coupling portion 133 may be stably fixed to each other simply by being positioned on a recessed portion 2110. However, a cell cover 130 and a side member 210 may be fixed by a fastening member 190 in order to prevent movement by external impact and vibration and to prevent movement along the height direction of an accommodating case 200.

A fastening member 190 may connect a cell cover 130 and a side member 210. A fastening member 190 may penetrate a cell cover 130 and be inserted into a side member 210 to connect the cell cover 130 and the side member 210. A fastening member 190 may be a bolt, but is not limited thereto.

FIG. 12 shows a diagram illustrating a cross-section taken along line AA′ of FIG. 10, and FIG. 13 shows a diagram illustrating a cross-section taken along line BB′ of FIG. 10.

Specifically, FIG. 12 shows a diagram illustrating a cross-section of an area where a coupling portion 133 is positioned on a recessed portion 2110. FIG. 12 shows an example of a battery assembly 1000 further including an accommodating cover 230 in FIG. 11. In other words, an accommodating cover 230 may cover an upper cover 120, and at least a part of an accommodating cover 230 may be positioned on a side member 210. An accommodating cover 230 may be penetrated by a fixing member 300 and fixed to a side member 210.

As described above, a cell cover 130 may extend toward the inside of a battery cell 10 to protect a lower portion of the battery cell 10. For example, a cell cover 130 may include a protecting portion 132 formed by extending along the-Y-axis direction, and the protecting portion may protect a protruding portion 15 of a battery cell 10.

One end of a tab portion 12 may protrude through a busbar assembly 150. A covering portion 131 may be positioned between a battery cell 10 and a side member 210 to cover a tab portion 12. Even when there is an external impact due to a covering portion 131, a tab portion 12 may be prevented from being damaged by a side member 210. Since a cell cover 130 may be coupled with a busbar assembly 150, the position may be stably maintained even when there is an impact. In an embodiment, a covering portion and a tab portion may be formed vertically.

A coupling portion 133 may protrude from a covering portion 131 toward a side member 210. In other words, a coupling portion 133 may protrude from a covering portion 131 along the +Y-direction. A coupling portion 133 may be positioned on a recessed portion 2110, and thus, movement of a cell cover 130 may be suppressed.

A fastening member 190 may penetrate a through-hole 1330, and at least a part of a fastening member 190 may be inserted into an insertion hole 2120. In other words, each coupling portion 133 and a side member 210 may be stably coupled by a fastening member 190.

When an upper cover 120 is disposed on a cell cover 130, a fastening member 190 may penetrate both the upper cover 120 and a cell cover 130. In other words, a fastening member 190 may penetrate an upper cover 120 and a cell cover 130, and at least a part of the fastening member 190 may be inserted into a side member 210. Through this, the upper cover 120 and the cell cover 130 may be fixed to the side member 210, and a plurality of battery cells 10 positioned inside can be stably fixed. In addition, by fixing an upper cover 120, which may protect a battery cell 10, to a side member 210 without additional components, the manufacturing cost can be reduced and the energy density of the battery assembly 1000 can be improved.

FIG. 13 shows a diagram illustrating a cross-section of an area that does not include a coupling portion 133 or a recessed portion 2110. Similarly, FIG. 13 shows an example of a battery assembly 1000 further including an accommodating cover 230 in FIG. 11. A cell cover 130 may still include a covering portion 131 supporting a tab portion 12 and a protecting portion 132 positioned at the bottom of a battery cell 10. However, a coupling portion 133 protruding into a side member 210 will not be formed.

Meanwhile, referring to FIGS. 12 and 13, the battery assembly 1000 of the present disclosure may further include a heat-conducting portion 250 applied to an accommodating case 200 and including a thermally conductive material. A heat-conducting portion 250 may be applied on an accommodating case 200 before a plurality of battery cells 10 are accommodated through an opening 221.

A heat-conducting portion 250 may include a material having heat conductivity and may further include an adhesive material. For example, it may be provided as a heat-conducting adhesive. Therefore, a plurality of battery cells 10 may be adhered to a bottom surface of an accommodating body 220 through a heat-conducting portion 250.

In addition, a pressurizing portion 240 of an elastic material may be included on one surface of an accommodating cover 230 facing a plurality of battery cells 10. This is to protect a battery cell 10. Since an exterior material 16 of a battery cell 10 may be damaged when a battery cell 10 is pressurized by an accommodating cover 230, a pressurizing portion 240 of an elastic material is added to alleviate the impact.

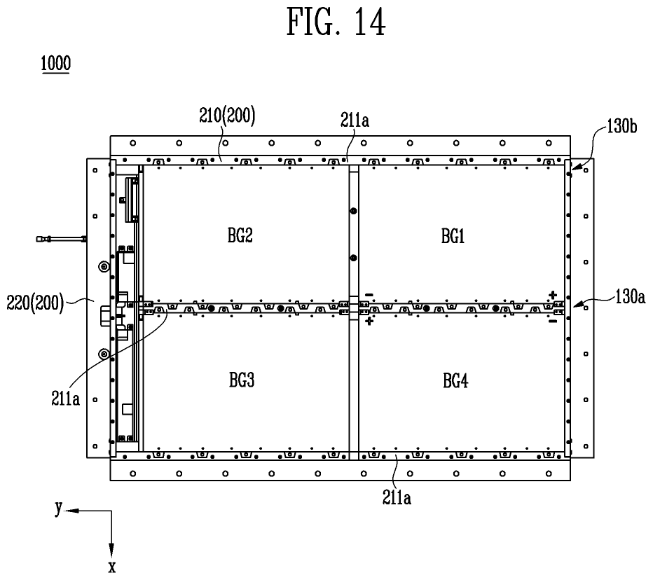

FIG. 14 shows a diagram illustrating a top view of a battery assembly 1000 according to one embodiment of the present disclosure.

A battery assembly may include a battery group formed by grouping a plurality of battery cells. A plurality of battery groups BG1, BG2, BG3, and BG4 may be positioned in an accommodating space. The shapes of cell covers positioned on both sides of each battery group may be different from each other. Referring to FIG. 3 again, the number and positions of coupling portions formed on a first cell cover 130a and a second cell cover 130b may be different from each other.

Referring to FIG. 14, a first cell cover 130a positioned at one end of one battery group BG1 and a second cell cover 130b positioned at the other end of one battery group BG1 may be formed differently from each other. For example, a coupling portion of a second cell cover 130b positioned on an upper portion may be formed as five pieces, but a coupling portion of a first cell cover 130a positioned on a lower portion may be formed as six pieces.

The reason why the shapes of a cell cover 130 are formed differently is to prevent a coupling portion 133 from being positioned at the same position and overlapping. In other words, the position of a coupling portion 133 of a cell cover 130 and the position of a recessed portion 2110 of a side member 210 may be changed, and the shapes of a first member 211a and a second member 212a may also be changed.

The present disclosure may be implemented in various forms, and the scope of the rights is not limited to the above-described embodiments. The contents described above are merely examples of applying the principles of the present disclosure, and other components may be further included without departing from the scope of the present disclosure.

What is claimed is:

1. A battery assembly comprising:
a plurality of battery cells disposed along a preset stacking direction;
a cell cover covering a tab portion protruding from one side of at least one battery cell among the plurality of battery cells;
an accommodating case accommodating the plurality of battery cells; and
a side member extending from the accommodating case toward the plurality of battery cells,
wherein at least a part of the cell cover is positioned on the upper portion of the side member and supported by the side member.

2. The battery assembly according to claim 1, wherein the cell cover includes a coupling portion provided to protrude toward the side member, and the coupling portion is positioned on the upper portion of the side member.

3. The battery assembly according to claim 2, wherein the coupling portion is formed in a plural number to be spaced apart along the stacking direction.

4. The battery assembly according to claim 2, wherein the coupling portion includes a through-hole formed along the height direction of the accommodating case.

5. The battery assembly according to claim 1, wherein the cell cover includes: a covering portion covering one surface where a tab portion of at least one battery cell is positioned; and a protecting portion extending from one end of the covering portion and positioned at a lower portion of at least one battery cell.

6. The battery assembly according to claim 1, wherein the side member includes a recessed portion formed to be recessed along the height direction of the accommodating case at a position corresponding to at least a part of the cell cover.

7. The battery assembly according to claim 1, further comprising a busbar assembly electrically connecting the plurality of battery cells, wherein the busbar assembly is positioned between the cell cover and the plurality of battery cells.

8. The battery assembly according to claim 7, the busbar assembly is possible to be coupled with the cell cover.

9. The battery assembly according to claim 1, further comprising an end plate positioned on the outside of the plurality of battery cells along the stacking direction.

10. The battery assembly according to claim 1, further comprising a fastening member connecting the cell cover and the side member.

11. The battery assembly according to claim 10, wherein the side member includes an insertion hole formed by recessing or penetrating an area along the height direction of the accommodating case.

12. The battery assembly according to claim 11, wherein the fastening member penetrates the cell cover, and one end of the fastening member is inserted into the insertion hole.

13. The battery assembly according to claim 1, further comprising an upper cover covering connected to the cell cover and covering an upper surface of the plurality of battery cells.

14. The battery assembly according to claim 13, wherein at least a part of the upper cover is positioned on an upper portion of the side member.

15. The battery assembly according to claim 14, further comprising a fastening member connecting at least one of the upper cover, the cell cover, and the side member.

16. The battery assembly according to claim 15, wherein the fastening member penetrates the upper cover and the cell cover, and at least a part of the fastening member is inserted into the side member.

17. The battery assembly according to claim 1, wherein the accommodating case further includes: an accommodating body including an opening on one side thereof and accommodating the plurality of battery cells through the opening; and an accommodating cover coupled with at least one of the accommodating body or the side member to close the opening.

18. The battery assembly according to claim 14, further comprising a pressurizing portion of an elastic material on one surface of the accommodating cover, the surface facing the plurality of battery cells.

19. The battery assembly according to claim 1, further comprising a heat-blocking member positioned to face an adjacent battery cell between the plurality of battery cells.

20. The battery assembly according to claim 1, further comprising a heat-conducting portion applied to the accommodating case and including a heat-conducting material.
